(19) United States
(12) Patent Application Publication
(10) Pub. No.: US 2026/0349490 A1
(43) Pub. Date: Nov. 5, 2026

(54) Rack Position Identification System for Server Information Handling System Rack

(71) Applicant: Dell Products L.P., Round Rock, TX (US)

(72) Inventors: Nikhil Sivanandaswami, Hyderabad (IN); Shivendra Katiyar, Bangalore (IN)

(21) Appl. No.: 19/198,372

(22) Filed: May 5, 2025

(51) Int. Cl. G06F 1/26; G06F 13/40

(52) U.S. Cl. CPC G06F 1/266; G06F 13/4068

(57) ABSTRACT

A rack position identification system for an information handling system server rack. The rack position identification system includes a power distribution component position indication device associated with a power distribution system, the power distribution component position indication device extending across the power distribution system; and, an information handling system position indication device associated with an information handling system mounted within the information handling system server rack, the information handling system position indication device interacting with the power distribution component device to identify a location of the information handling system.

### BACKGROUND OF THE INVENTION

### Field of the Invention

The present invention relates to information handling systems. More specifically, embodiments of the invention relate to server type information handling systems within information technology (IT) environments.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems and related IT systems within information technology (IT) environments such as data centers.

### SUMMARY OF THE INVENTION

A system and method for providing an information handling system server rack with a rack position identification system.

In one embodiment, the invention relates to a rack position identification system for an information handling system server rack, comprising: a power distribution component position indication device associated with a power distribution system, the power distribution component position indication device extending across the power distribution system; and, an information handling system position indication device associated with an information handling system mounted within the information handling system server rack, the information handling system position indication device interacting with the power distribution component device to identify a location of the information handling system.

In another embodiment, the invention relates to an information handling system server rack comprising: a server rack; and, a power distribution system mounted to the server rack panel, the power distribution system comprising: a power distribution device, the power distribution device extending across the information handling system server rack; and, a power distribution component position indication device associated with the power distribution device, the power distribution component position indication device extending across the power distribution device, the power distribution component position indication device being configured to interact with an information handling system position indication device to identify a location of an information handling system.

In another embodiment, the invention relates to an information handling system comprising: a processor; and, a power system for providing power to the processor, the power system comprising an information handling system position indication device, the information handling system position indication device being configured to interact with a power distribution component position indication device of a power distribution system when the information handling system is mounted within an information handling system server rack to identify a location of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a perspective view of a portion of a data center within an IT environment.

FIGS. 3A, 3B and 3C, generally referred to as FIG. 3, show a rack front view, a rack side view, and a rack side view with an information handling system.

FIG. 4 shows a block diagram view of a server rack system with a power distribution system.

FIG. 5 shows a perspective view of a portion of a power distribution system having a power distribution system rack position identification system.

FIG. 6 shows block diagram view of a power distribution component position indication device of a rack position identification system.

FIG. 7A shows a perspective view of a rear portion of a server information handling system having an information handling system position indication device.

FIG. 7B shows a perspective view of a power distribution component having an information handling system position indication device.

FIG. 8 shows block diagram view of an information handling system position indication device.

### DETAILED DESCRIPTION

Various aspects of the present disclosure include an appreciation that it is known to mount a plurality of information handling systems within a server rack. Various aspects of the present disclosure include an appreciation that data centers often include a plurality of server racks, each including multiple information handling systems such as compute devices, storage devices, networking devices, power supply devices, etc. Various aspects of the present disclosure include an appreciation that managing the actual physical location of a device in the datacenter can be challenging. Various aspects of the present disclosure include an appreciation that actual physical location of a device in the datacenter is often managed by manually created records. Various aspects of the present disclosure include an appreciation that manually created records can often become out of date as devices are relocated within the data center such as during maintenance activities. Various aspects of the present disclosure include an appreciation that determining a slot position of a device within a server rack is often performed via a manual configuration process.

Various aspects of the present disclosure include an appreciation that it is known to provide power to a plurality of devices within a server rack via a power distribution system. Various aspects of the present disclosure include an appreciation that a power distribution system is often configured as a busbar. Various aspects of the present disclosure include an appreciation that busbars are often configured as a metallic strip which provides power to the plurality of devices. Various aspects of the present disclosure include an appreciation that busbars are often mounted to a rear of a server rack and extend vertically across the rear of the server rack.

Various aspects of the present disclosure include an appreciation that it would be desirable to provide a means for automatically determining a physical location of a device within a server rack, within a data center, or a combination thereof.

A system and method are disclosed for providing a rack position identification system. In certain embodiments, the rack position identification system performs a rack position identification operation. In certain embodiments, the rack position identification operation enables self-determination of rack position for a device mounted in the rack. In certain embodiments, the rack position identification system includes a power distribution component position indication device, an information handling system position indication device, or a combination thereof.

In certain embodiments, the power distribution component position indication device includes a plurality of position indicia. In certain embodiments, each of the plurality of position indicia includes a passive contact pad. In certain embodiments, the plurality of position indicia are positioned across the power distribution component. In certain embodiments, power distribution component position indication device is embedded with the power distribution component. In certain embodiments, power distribution component position indication device is configured as a strip which is affixed to the power distribution component. In certain embodiments, the strip is affixed to the power distribution component during rack deployment.

In certain embodiments, the position indicia are positioned at predefined locations along the power distribution component. In certain embodiments, the position indicia are positioned at one or more open unit (OU) slot locations along the power distribution component. In certain embodiments, the position indicia are positioned at each open unit (OU) slot locations along the power distribution component. In certain embodiments, each open unit slot location is associated with a rack unit.

In certain embodiments, each position indicia is divided into a plurality of segments. In certain embodiments, the plurality of segments of a particular position indicia are configured according to a pattern according to the position of the position indicia within the rack. In certain embodiments, the pattern of the particular position indicia is unique. In certain embodiments, the pattern of the particular position indicia is correlated to a particular rack slot location. In certain embodiments, certain segments have electrical connectivity. In certain embodiments, certain segments are configured with conductive tabs. In certain embodiments, an input segment is electrically coupled to the certain segments according to the pattern correlated to the particular rack slot. In certain embodiments, the pattern encodes a corresponding numerical value.

In certain embodiments, the information handling system position indication device is associated with a blind mate power connector. In certain embodiments, the blind mate power connector conforms to a blind mate specification. In certain embodiments, the blind mate specification is included within a rack specification. In certain embodiments, the rack specification includes the Open Rack Specification Version 3 (ORv3) specification.

In certain embodiments, the information handling system position indication device includes a set of electrically conductive pins. In certain embodiments, the set of electrically conductive pins includes a voltage pin and a plurality of reader pins. In certain embodiments, the set of electrically conductive pins are positioned to interact with a position indicia when the device is inserted into the rack. In certain embodiments, the set of electrically conductive pins are included with the blind mate power connector. In certain embodiments, the information handling system position indication device is positioned on an outside wall of the blind mate power connector.

In certain embodiments, the information handling system position indication device delivers a voltage and current to the position indicia when the device is inserted into the rack. In certain embodiments, the voltage is low voltage, low current (e.g., 1.5 volt-5 volt) direct current. In certain embodiments, the voltage is delivered through the voltage pin from the set of electrically conductive pins. Depending on the slot position, a subset of remaining pins will also receive the same current which can then be sensed by the corresponding reader pins. In certain embodiments, the information handling system position indication device uses the current sensed by the reader pins to generate a bit stream representing a number. In certain embodiments, the number represents a rack slot position.

In certain embodiments, the power distribution component is configured as a busbar. In certain embodiments, the rack position identification operation uses a combination of passive contact pads associated with busbar and a set of pins embedded on the device power connector to perform the self-determination of rack position.

In certain embodiments, the rack position identification system provides rack position information to a management controller. In certain embodiments, the set of contact pins function as a sensor which is accessible by the management controller of the device. In certain embodiments, the management controller derives a rack position using the rack position information. In certain embodiments, the management controller includes a baseboard management controller (BMC). In certain embodiments, the baseboard management controller includes an out of band remote access controller such as the iDRAC remote access controller available from Dell Inc. In certain embodiments, rack position information from a plurality of devices are provided to a rack management console such as an integrated management console (IMC) or an open manage essentials (OME) type management console.

Such a rack position identification system advantageously presents a low-cost solution that enables a device to infer its rack slot position by using a combination of passive contact pads on the busbar and a set of pins that is embedded on the device power connector. Such a rack position identification system advantageously provides a generic solution that can be adopted by a plurality of devices including storage devices, network switches, power shelves. etc. In certain embodiments, the rack position identification system may be implemented on any ORv3 complaint device. Such a rack position identification system advantageously reports an accurate slot position even after re-arrangement in rack without needing any manual configuration. Such a rack position identification system advantageously provides a low cost and low complexity solution that does not require any programmable components.

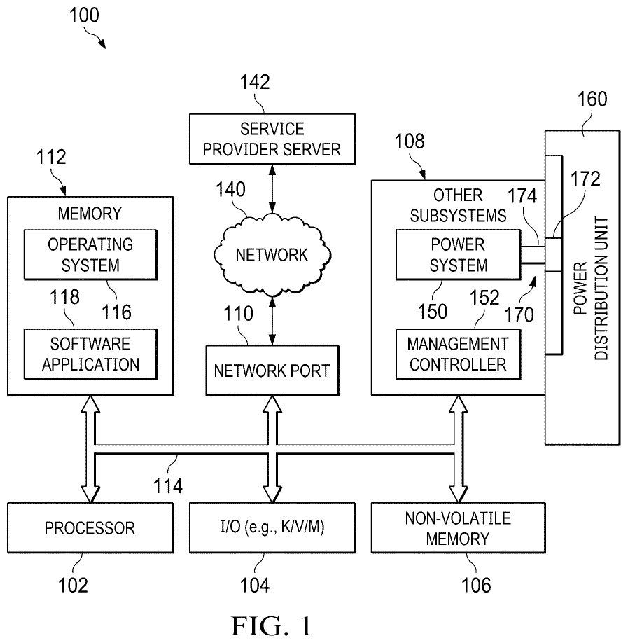

FIG. 1 shows a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116. In certain embodiments, the information handling system 100 is one of a plurality of information handling systems within a data center. In certain embodiments, the information handling system 100 comprises a server type information handling system. In certain embodiments, the server type information handling system is configured to be mounted within a server rack.

In certain embodiments, the information handling system 100 comprises a server type information handling system. In certain embodiments, the server type information handling system comprises a rack server type information handling system. As used herein, a rack server type information handling system broadly refers to an information handling system which is physically configured to be mounted within a server rack.

In certain embodiments, the information handling system 100 includes a power system 150, a management controller 152, or a combination thereof. In certain embodiments, the power system 150 of the information handling system is coupled to a power distribution system 160. In certain embodiments, the power system 150, the power distribution system 160, or a combination thereof, are coupled to a rack position identification system 170. In certain embodiments, the rack position identification system 170 includes a power distribution component position indication device 172, an information handling system position indication device 174, or a combination thereof. In certain embodiments, the power system 150 includes one or more system power distribution components, one or more power supplies, or a combination thereof. In certain embodiments, the one or more system power distribution components, the one or more power supplies, or a combination thereof, power various components of the information handling system 100. In certain embodiments, the power distribution system 160 is configured to be installed to a server rack. In certain embodiments, the power distribution system 160 includes one or more busbars.

In certain embodiments, the rack position identification system 170 performs a rack position identification operation. As used herein, a rack position identification operation broadly refers to any task, function, operation, procedure, or process performed, directly or indirectly, to use a power distribution system to automatically identify a location of an information handling system within a data center. In certain embodiments, the location includes a rack slot location, a rack location, or a combination thereof. In certain embodiments, the rack position identification operation enables self-determination of rack position for a device mounted in the rack.

In certain embodiments, the power distribution component position indication device 172 includes a plurality of position indicia. In certain embodiments, each of the plurality of position indicia includes a passive contact pad. In certain embodiments, the plurality of position indicia are positioned across the power distribution component. In certain embodiments, power distribution component position indication device 172 is embedded with the power distribution component 160. In certain embodiments, power distribution component position indication device 172 is configured as a strip which is affixed to the power distribution component 160. In certain embodiments, the strip is affixed to the power distribution component during rack deployment.

In certain embodiments, the position indicia are positioned at predefined locations along the power distribution component 160. In certain embodiments, the position indicia are positioned at one or more open unit (OU) slot locations along the power distribution component 160. In certain embodiments, the position indicia are positioned at each open unit (OU) slot locations along the power distribution component 160. In certain embodiments, each open unit slot location is associated with a rack unit.

In certain embodiments, each position indicia is divided into a plurality of segments. In certain embodiments, the plurality of segments of a particular position indicia are configured according to a pattern according to the position of the position indicia within the rack. In certain embodiments, the pattern of the particular position indicia is unique. In certain embodiments, the pattern of the particular position indicia is correlated to a particular rack slot location. In certain embodiments, certain segments have electrical connectivity. In certain embodiments, certain segments are configured with conductive tabs. In certain embodiments, an input segment is electrically coupled to the certain segments according to the pattern correlated to the particular rack slot. In certain embodiments, the pattern encodes a corresponding numerical value.

In certain embodiments, the information handling system position indication device 174 is associated with a blind mate power connector. In certain embodiments, the blind mate power connector conforms to a blind mate specification. In certain embodiments, the blind mate specification is included within a rack specification. In certain embodiments, the rack specification includes the Open Rack Specification Version 3 (ORv3) specification.

In certain embodiments, the information handling system position indication device 174 includes a set of electrically conductive pins. In certain embodiments, the set of electrically conductive pins includes a voltage pin and a plurality of reader pins. In certain embodiments, the set of electrically conductive pins are positioned to interact with a position indicia when the device is inserted into the rack. In certain embodiments, the set of electrically conductive pins are included with the blind mate power connector. In certain embodiments, the information handling system position indication device 174 is positioned on an outside wall of the blind mate power connector.

In certain embodiments, the information handling system position indication device 174 delivers a voltage and current to the position indicia when the device is inserted into the rack. In certain embodiments, the voltage is low voltage, low current (e.g., 1.5 volt-5 volt) direct current. In certain embodiments, the voltage is delivered through the voltage pin from the set of electrically conductive pins. Depending on the slot position, a subset of remaining pins will also receive the same current which can then be sensed by the corresponding reader pins. In certain embodiments, the information handling system position indication device uses the current sensed by the reader pins to generate a bit stream representing a number. In certain embodiments, the number represents a rack slot position.

In certain embodiments, the power distribution component 160 is configured as a busbar. In certain embodiments, the rack position identification operation uses a combination of passive contact pads associated with busbar and a set of pins embedded on the device power connector to perform the self-determination of rack position.

In certain embodiments, the rack position identification system provides rack position information to the management controller 152. In certain embodiments, the set of contact pins function as a sensor which is accessible by the management controller 152 of the information handling system 100. In certain embodiments, the management controller 152 derives a rack position using the rack position information. In certain embodiments, the management controller 152 includes a baseboard management controller (BMC). In certain embodiments, the baseboard management controller includes an out of band remote access controller such as the iDRAC remote access controller available from Dell Inc. In certain embodiments, rack position information from a plurality of devices are provided to a rack management console such as an integrated management console (IMC) or an open manage essentials (OME) type management console.

Such a rack position identification system advantageously presents a low-cost solution that enables a device to infer its rack slot position by using a combination of passive contact pads on the busbar and a set of pins that is embedded on the device power connector. Such a rack position identification system advantageously provides a generic solution that can be adopted by a plurality of devices including storage devices, network switches, power shelves. etc. In certain embodiments, the rack position identification system may be implemented on any ORv3 complaint device. Such a rack position identification system advantageously reports an accurate slot position even after re-arrangement in rack without needing any manual configuration. Such a rack position identification system advantageously provides a low cost and low complexity solution that does not require any programmable components.

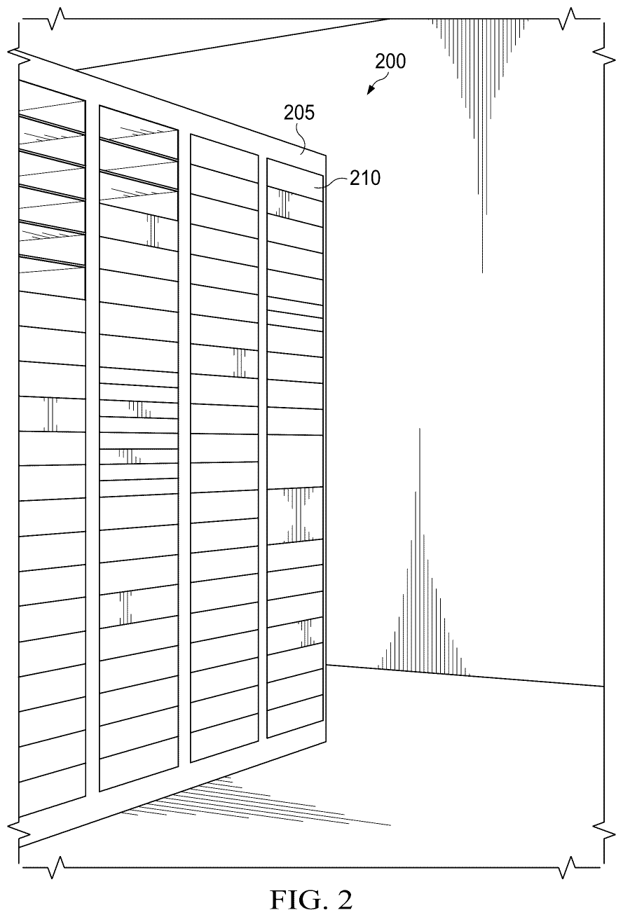

FIG. 2 shows a perspective view of a portion of an IT environment 200. The IT environment includes one or more racks 205 which include a plurality of information handling systems 100, often referred to as a server rack. In various embodiments, the IT environment 200 comprises a data center. As used herein, a data center refers to an IT environment which includes a plurality of networked information handling systems 100. In various embodiments, the information handling systems 100 of the data center include some or all of router type information handling systems, switch type information handling systems, firewall type information handling systems, storage system type information handling systems, server type information handling systems and application delivery controller type information handling systems. In certain environments, the information handling systems 100 are mounted within respective racks. As used herein, a rack refers to a physical structure that is designed to house the information handling systems 100 as well as the associated cabling and power provision for the information handling systems. In certain embodiments, a rack includes side panels to which the information handling systems are mounted. In certain embodiments, the rack includes a top panel and a bottom panel to which the side panels are attached. In certain embodiments, the side panels each include a front side panel and a rear side panel.

In certain embodiments, a plurality of racks is arranged continuous with each other to provide a rack system. An IT environment can include a plurality of rack systems arranged in rows with aisles via which IT service personnel can access information handling systems mounted in the racks. In certain embodiments, the aisles can include front aisles via which the front of the information handling systems may be accessed and hot aisles via which the infrastructure (e.g., data and power cabling) of the IT environment can be accessed.

Each respective rack includes a plurality of vertically arranged information handling systems 210. In certain embodiments, the information handling systems may conform to one of a plurality of standard server sizes. In certain embodiments, the plurality of server sizes conforms to particular rack unit sizes (i.e., rack units). As used herein, a rack unit broadly refers to a standardized server system height. As is known in the art, a server system height often conforms to one of a 1U rack unit, a 2U rack unit and a 4U rack unit. In general, a 1U rack unit is substantially (i.e., +/−20%) 1.75″ high, a 2U rack unit is substantially (i.e., +/−20%) 3.5″ high and a 4U rack height is substantially (i.e., +/−20%) 7.0″ high. In certain embodiments, the plurality of service sizes includes open rack (OU) server sizes. As used herein, an open rack server size broadly refers to a standardized server system height conforming to an OpenRack standard.

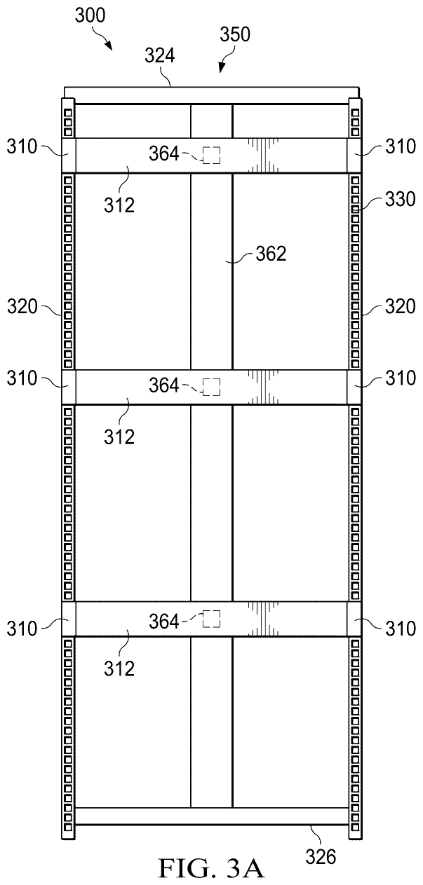

FIGS. 3A, 3B and 3C show a rack front view, a rack side view, and a rack rear view of a rack system 300 in which information handling systems 305 may be mounted. For illustration purposes, the information handling systems 305 are only shown in FIGS. 3B and 3C. In certain embodiments, the information handling systems 305 include server type information handling systems, a power shelf, or a combination thereof.

In certain embodiments, the rack system 300 includes a first front side panel 320, a second front side panel 320, a first rear side panel 322, a second rear side panel 322, or a combination thereof. In certain embodiments, the rack further includes a top panel 324, a bottom panel 326, or a combination thereof. A first server mounting component 310 is attached to one side of the rack and a second server mounting component 310 is attached to another side of the rack 300. In certain embodiments, the first server mounting component is attached to a first front side panel 320 and a first rear side panel 322 of the rack 300. In certain embodiments, the second server mounting component is attached to a second front side panel 320 and a second rear side panel 322 of the rack 300. In certain embodiments, a rear mounting component 312 is attached between the first and second rear side panels 322. In certain embodiments, the first server mounting component 320 is attached via the mounting apertures 330. In certain embodiments, the second server mounting component is attached via the mounting apertures 330.

In certain embodiments, the rack has a plurality of dimensions. In certain embodiments, the plurality of dimensions includes a width dimension, a depth dimension, a height dimension, or a combination thereof. In certain embodiments, the width dimension is defined by a distance from the first front side panel 320 and the second front side panel 320. In certain embodiments, the depth dimension of the rack is defined by a distance from a front side panel 320 and a rear side panel 322. In certain embodiments, the height dimension is defined by a distance from a bottom of a side panel 320 to a top of the side panel 320.

In certain embodiments, a rack includes a plurality of vertically arranged mounting components. In certain embodiments, some or all of the vertically arranged mounting components are adapted to mount respective rack server type information handling systems to the rack. In certain embodiments, the server mounting components are configured to correspond to particular heights including rack unit heights and open unit heights.

In certain embodiments, the information handling system 100 comprises a server type information handling system. In certain embodiments, the server type information handling system comprises a rack server type information handling system. As used herein, a rack server type information handling system broadly refers to an information handling system which is physically configured to be mounted within a server rack.

In certain embodiments, the rack system 300 includes a power distribution system 350. In certain embodiments, the power distribution system 350 corresponds to power distribution system 160. In certain embodiments, the power distribution system 350 is configured to be installed to the server rack 300. In certain embodiments, the power distribution system 350 is configured to be installed on a rear portion of the server rack 300. In certain embodiments, the power distribution system 350 extends vertically across a rear portion of the server rack 300. In certain embodiments, the power distribution system 350 is attached to the top panel 324, the bottom panel 326, or a combination thereof. In certain embodiments, the power distribution system 350 includes a busbar 360. In certain embodiments, some or all of the rear mounting components 312 define power apertures 364. In certain embodiments, server type information handling systems 305 may be physically and electrically coupled to the busbar 360 through the power apertures 364.

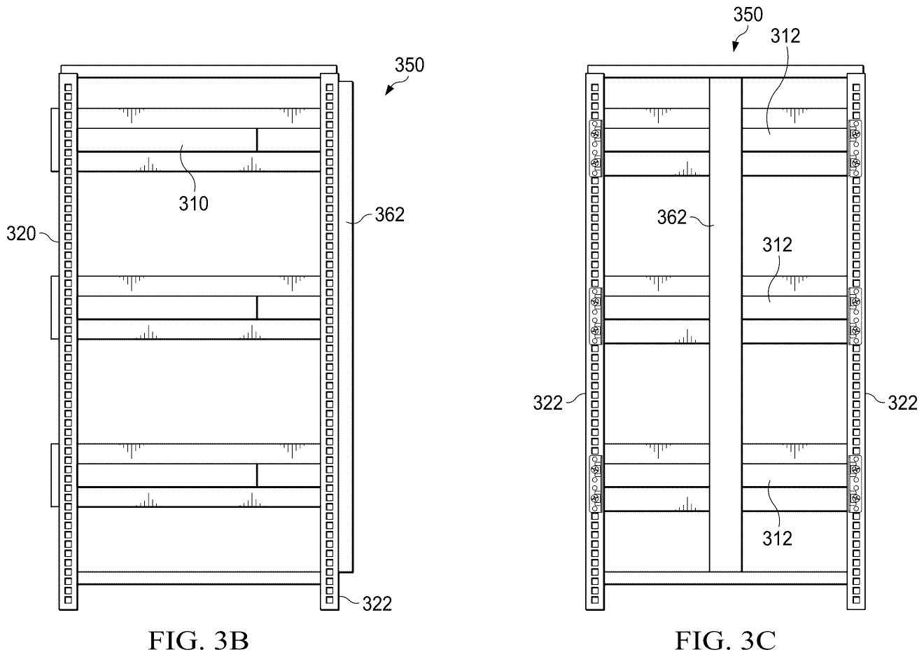

FIG. 4 shows a block diagram view of a server rack system 400 with a power distribution system 405 and a plurality of information handling systems 410. In certain embodiments, the server rack system 400 corresponds to server system 300. In certain embodiments, the power distribution system 405 corresponds to power distribution system 160. In certain embodiments, the information handling systems 410 include server type information handling systems 410a, power shelves 410b, or a combination thereof. In certain embodiments, power shelves 410b are located between at least pairs of server type information handling system 410a. In certain embodiments, at least pairs of server type information handling systems 410a are located above and below respective power shelves 410b.

In certain embodiments, the power distribution system 405 is configured to be installed to the server rack 400. In certain embodiments, the power distribution system 405 is configured to be installed on a rear portion of the server rack 400. In certain embodiments, the power distribution system 405 extends vertically across a rear portion of the server rack 400. In certain embodiments, the power distribution system 405 includes a power distribution device 420. In certain embodiments, the power distribution device 420 includes a busbar. In certain embodiments, the power distribution device 420 extends vertically across a rear portion of the server rack 400.

In certain embodiments, some or all of the information handling system 410 include power clips 430. In certain embodiments, the power clips 430 are configured to physically and electrically couple the information handling systems to the power distribution device 420. In certain embodiments, server type information handling systems 405 may be physically and electrically coupled to the power distribution device 420. In certain embodiments, one or more of the power clips 430 includes a respective information handling system position indication device.

In certain embodiments, the power distribution device 420 includes an associated power distribution component position indication device 440. In certain embodiments, the power distribution component position indication device 440 includes a plurality of position indicia 442. In certain embodiments, each of the plurality of position indicia 442 includes a passive contact pad. In certain embodiments, the plurality of position indicia 442 are positioned across the power distribution component. In certain embodiments, power distribution component position indication device 440 is embedded with the power distribution device 420. In certain embodiments, power distribution component position indication device 440 is configured as a strip which is affixed to the power distribution device 420. In certain embodiments, the strip is affixed to the power distribution device 420 during rack deployment.

In certain embodiments, the position indicia 442 are positioned at predefined locations along the power distribution component 160. In certain embodiments, the position indicia 442 are positioned at one or more open unit (OU) slot locations along the power distribution device 420. In certain embodiments, the position indicia 442 are positioned at each open unit (OU) slot locations along the power distribution device 442. In certain embodiments, each open unit slot location is associated with a rack unit.

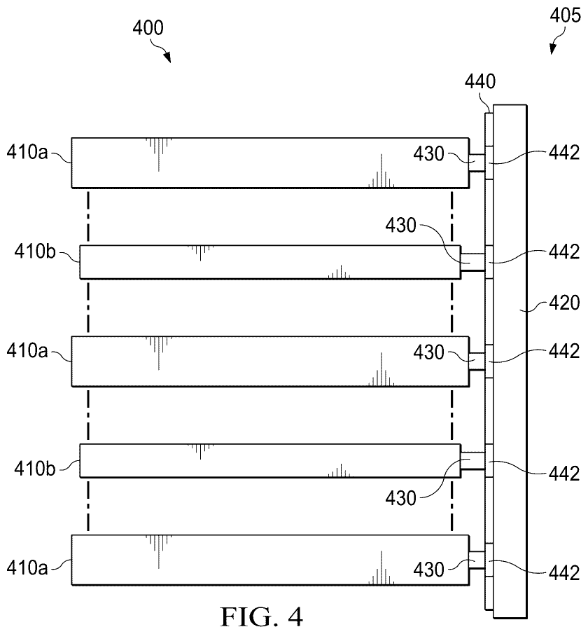

FIG. 5 shows a perspective view of a portion of a power distribution system 500 having a power distribution system rack position identification device 505. In certain embodiments, the power distribution system 500 corresponds to power distribution system 160. In certain embodiments, the power distribution system rack position identification device 505 corresponds to power distribution system rack position identification device 172. In certain embodiments, the power distribution system 500 includes one or more busbars.

In certain embodiments, the power distribution component position indication device 505 includes a plurality of position indicia 510. In certain embodiments, the busbar includes a busbar housing 520, a power distribution component 522, or a combination thereof. In certain embodiments, the busbar housing 520 includes first and second walls extending from a rear wall. In certain embodiments, the power distribution component 522 extends from the rear wall. In certain embodiments, the power distribution system rack position identification device 505 is located on an interior wall 530 of at least one of the first and second walls extending from the rear wall of the busbar housing 520.

In certain embodiments, each of the plurality of position indicia 510 includes a passive contact pad. In certain embodiments, the plurality of position indicia 510 are positioned across the power distribution system 505. In certain embodiments, the plurality of position indicia 510 are vertically distributed across the power distribution system 505. In certain embodiments, power distribution component position indication device 505 is embedded with the power distribution system 500. In certain embodiments, power distribution component position indication device 505 is configured as a strip which is affixed to the power distribution system 500. In certain embodiments, the strip is affixed to the power distribution component during rack deployment.

In certain embodiments, the position indicia 510 are positioned at predefined locations along the power distribution system 500. In certain embodiments, the position indicia 510 are positioned at one or more open unit (OU) slot locations along the power distribution system 500. In certain embodiments, the position indicia 510 are positioned at each open unit (OU) slot locations along the power distribution system 500. In certain embodiments, each open unit slot location is associated with a rack unit.

In certain embodiments, each position indicia 510 is divided into a plurality of segments. In certain embodiments, the plurality of segments of a particular position indicia 510 are configured according to a pattern according to the position of the position indicia within the rack. In certain embodiments, the pattern of the particular position indicia within the power distribution system 500 is unique. In certain embodiments, the pattern of the particular position indicia is correlated to a particular rack slot location. In certain embodiments, certain segments have electrical connectivity. In certain embodiments, certain segments are configured to have electrical connectivity via conductive tabs. In certain embodiments, a voltage input segment is electrically coupled to the certain segments according to the pattern correlated to the particular rack slot. In certain embodiments, the pattern encodes a corresponding numerical value. In certain embodiments, a conductive tab being present is encoded as a binary ‘1’ and a conductive tab not being present is encoded as a binary ‘0.’ Accordingly, when there are seven segments, a seven bit binary number may be encoded by each position indica.

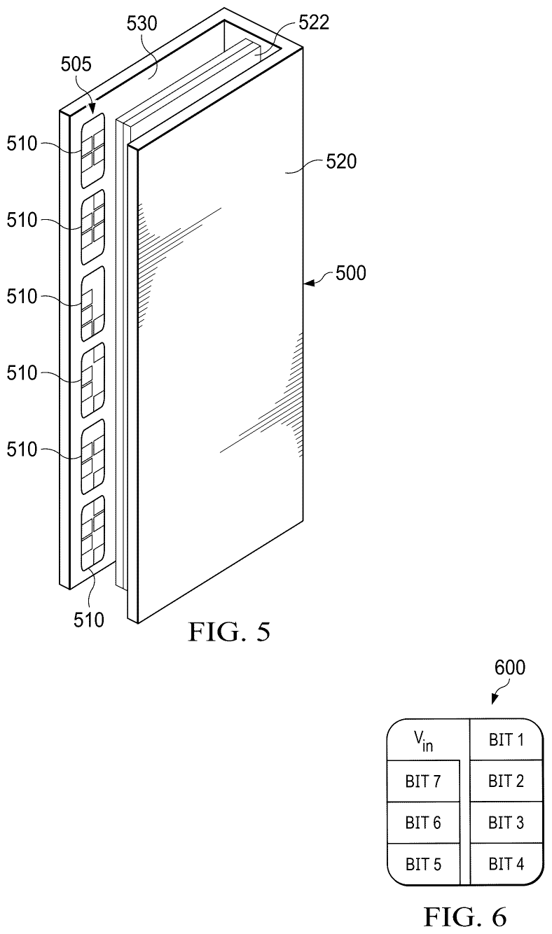

FIG. 6 shows block diagram view of a position indicia 600 of a rack position identification system. In certain embodiments, the position indicia 600 corresponds to the position indicia of power distribution system rack position identification device 172.

In certain embodiments, each position indicia 600 is configured as a contact pad. In certain embodiments, each contact pad is configured as a passive contact pad. In certain embodiments, each contact pad is divided into a plurality of segments. In certain embodiments, each contact pad is divided into eight segments. In certain embodiments, each position indicia 600 includes a voltage input segment (Vin) and a plurality of bit segments (Bit1-Bit7). In certain embodiments, the voltage input segment is electrically coupled to a subset of the plurality of bit segments, determined by the slot number. In certain embodiments, electrical connectivity among these segments follows a pattern that is correlated to the rack slot location. In certain embodiments, the plurality of segments of a particular position indicia 600 are configured according to a pattern according to the position of the position indicia within the rack.

In certain embodiments, the pattern of the particular position indicia 600 within the power distribution system is unique. In certain embodiments, the pattern of the particular position indicia 600 is correlated to a particular rack slot location. In certain embodiments, certain segments have electrical connectivity. In certain embodiments, certain segments are configured with conductive tabs. In certain embodiments, the voltage input segment is electrically coupled to the certain segments according to the pattern correlated to the particular rack slot. In certain embodiments, the pattern encodes a corresponding numerical value. In certain embodiments, each pad is unique and encodes a numerical value between 1 and maximum slot number up to 127.

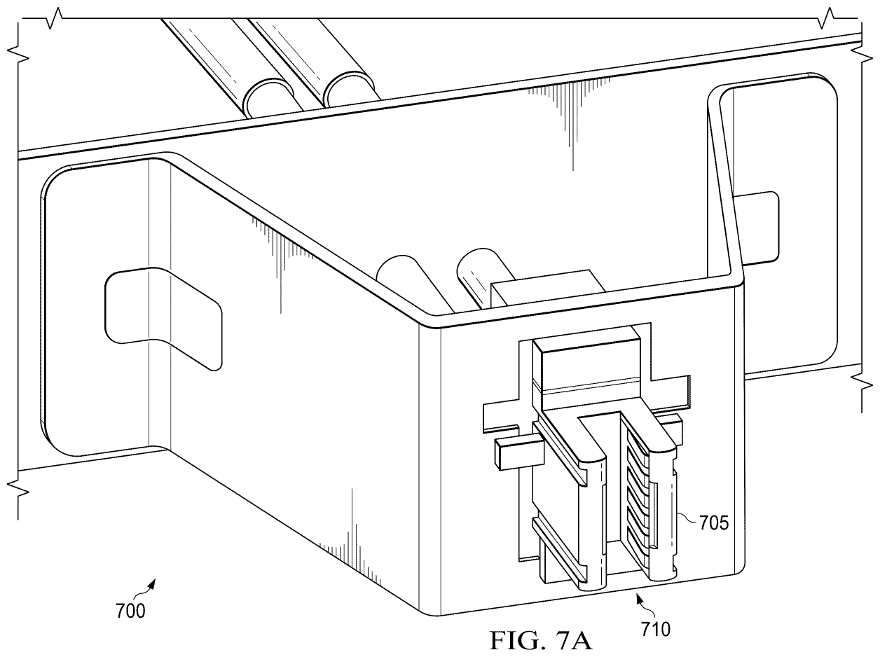

FIG. 7A shows a perspective view of a rear portion of a server information handling system 700 having an information handling system position indication device 705. FIG. 7B shows a perspective view of a power distribution component 710 having an information handling system position indication device 705. In certain embodiments, the information handling system position indication device 705 corresponds to information handling system position indication device 174.

In certain embodiments, the information handling system position indication device 705 is associated with the power distribution component 710. In certain embodiments, the power distribution component is configured as a blind mate power connector. In certain embodiments, the information handling system position indication device 705 is mounted to an outside wall 720 of the blind mate power connector. In certain embodiments, the blind mate power connector conforms to a blind mate specification. In certain embodiments, the blind mate specification is included within a rack specification. In certain embodiments, the rack specification includes the Open Rack Specification Version 3 (ORv3) specification.

In certain embodiments, the information handling system position indication device 705 includes a set of electrically conductive pins. In certain embodiments, the set of electrically conductive pins includes a voltage pin and a plurality of reader pins. In certain embodiments, the set of electrically conductive pins are positioned to interact with a position indicia when the device is inserted into the rack. In certain embodiments, the set of electrically conductive pins are associated with the blind mate power connector. In certain embodiments, the information handling system position indication device 705 is positioned on an outside wall of the blind mate power connector.

In certain embodiments, the information handling system position indication device 705 delivers a voltage and current to the position indicia when the device is inserted into the rack. In certain embodiments, the voltage is low voltage, low current (e.g., 1.5 volt-5 volt) direct current. In certain embodiments, the voltage is delivered through the voltage pin from the set of electrically conductive pins. Depending on the slot position, a subset of remaining pins will also receive the same current which can then be sensed by the corresponding reader pins. In certain embodiments, the information handling system position indication device uses the current sensed by the reader pins to generate a bit stream representing a number. In certain embodiments, the number represents a rack slot position.

In certain embodiments, the information handling system position indication device 705 provides rack position information to a management controller. In certain embodiments, the set of contact pins function as a sensor which is accessible by a management controller of the information handling system 700. In certain embodiments, the management controller derives a rack position using the rack position information. In certain embodiments, the management controller includes a baseboard management controller (BMC). In certain embodiments, the baseboard management controller includes an out of band remote access controller such as the iDRAC remote access controller available from Dell Inc. In certain embodiments, rack position information from a plurality of devices are provided to a rack management console such as an integrated management console (IMC) or an open manage essentials (OME) type management console. In certain embodiments, the rack position information is read by the management controller for native ORv3 complaint devices. In certain embodiments, for non-ORv3 compliant type devices that use canister or enclosures for mounting in the rack, the rack position information is transferred over a standard interface such as a universal serial bus (USB) for consumption by the management controller.

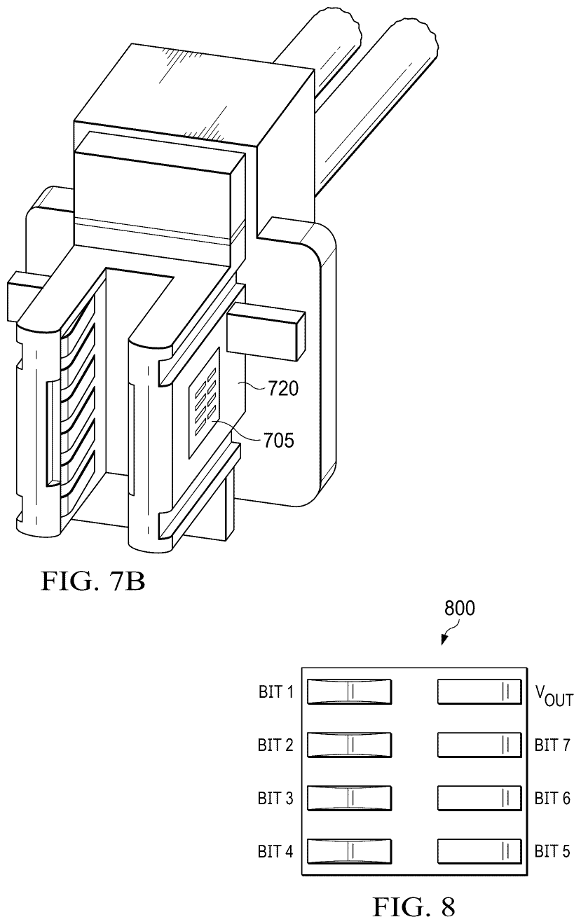

FIG. 8 shows block diagram view of an information handling system position indication device 800. In certain embodiments, the information handling system position indication device 800 corresponds to information handling system position indication device 174.

In certain embodiments, the information handling system position indication device 800 includes a set of electrically conductive pins. In certain embodiments, the set of electrically conductive pins includes a voltage pin (Vout) and a plurality of reader pins (Bit1-Bit7). In certain embodiments, the set of electrically conductive pins are positioned to interact with a position indicia when the device is inserted into the rack. In certain embodiments, the set of electrically conductive pins are positioned to correspond with the plurality of segments of the contact pad of the position indicia when the device is inserted into the rack. In certain embodiments, the set of electrically conductive pins are included with the blind mate power connector. In certain embodiments, the information handling system position indication device 800 is positioned on an outside wall of the blind mate power connector.

In certain embodiments, the information handling system position indication device 800 delivers a voltage and current to the position indicia when the device is inserted into the rack. In certain embodiments, the voltage is low voltage, low current (e.g., 1.5 volt-5 volt) direct current. In certain embodiments, the voltage is delivered through the voltage pin from the set of electrically conductive pins. Depending on the slot position, a subset of remaining pins of the contact pad of the position indicia will also receive the same current which can then be sensed by the corresponding reader pins. In certain embodiments, the information handling system position indication device uses the current sensed by the reader pins to generate a bit stream representing a number. In certain embodiments, the number represents a rack slot position. In certain embodiments, the slot position is represented by a numerical value between 1 and 127.

Other embodiments are within the following claims. For example, the contact pad and the information handling system position indication device can each include fewer or more contact segments, thus resulting in fewer or more possible unique position indications. Also for example, additional unique position indications could also be used to indicate a rack location in addition to a slot position. Also for example, the rack position identification system could include additional power distribution component position indication devices, additional information handling system position indication devices, or a combination thereof. For example, the rack position identification system could include power distribution component position indication devices positioned on opposing interior walls of the power distribution component as well as additional information handling system position indication devices positioned on each outside wall of respective blind mate power connector. Also for example, the additional power distribution component position indication devices and the additional information handling system position indication devices could also be used to indicate a rack location within a data center in addition to a slot position.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A rack position identification system for an information handling system server rack, comprising:
a power distribution component position indication device associated with a power distribution system, the power distribution component position indication device extending across the power distribution system; and,
an information handling system position indication device associated with an information handling system mounted within the information handling system server rack, the information handling system position indication device interacting with the power distribution component device to identify a location of the information handling system.

2. The rack position identification system of claim 1, wherein:
the power distribution system includes a busbar; and,
the power distribution component position indication device is mounted within the busbar.

3. The rack position identification system of claim 2, wherein:
the busbar includes a busbar housing, the busbar housing including a rear wall, a first side wall and a second side wall; and,
the power distribution component position indication device is mounted on an interior wall of at least one of the first side wall and the second side wall.

4. The rack position identification system of claim 1, wherein:
the power distribution component position indication device includes a plurality of position indicia, the plurality of position indicia being positioned at predefined locations along the power distribution system; and,
the information handling system position indication device interacts at least one of the plurality of position indica to identify a location of the information handling system.

5. The rack position identification system of claim 1, wherein:
the information handling system includes a power clip; and,
the information handling system position indication device is mounted to the power clip.

6. The rack position identification system of claim 5, wherein:
the information handling system position indication device is mounted to an outside wall of the power clip.

7. An information handling system server rack comprising:
a server rack; and,
a power distribution system mounted to the server rack panel, the power distribution system comprising:
a power distribution device, the power distribution device extending across the information handling system server rack; and,
a power distribution component position indication device associated with the power distribution device, the power distribution component position indication device extending across the power distribution device, the power distribution component position indication device being configured to interact with an information handling system position indication device to identify a location of an information handling system.

8. The information handling system server rack of claim 7, wherein:
the power distribution system includes a busbar; and,
the power distribution component position indication device is mounted within the busbar.

9. The information handling system server rack of claim 8, wherein:
the busbar includes a busbar housing, the busbar housing including a rear wall, a first side wall and a second side wall; and,
the power distribution component position indication device is mounted on an interior wall of at least one of the first side wall and the second side wall.

10. The information handling system server rack of claim 7, wherein:
the power distribution component position indication device includes a plurality of position indicia, the plurality of position indicia being positioned at predefined locations along the power distribution system; and,
the information handling system position indication device interacts at least one of the plurality of position indica to identify a location of the information handling system.

11. The information handling system server rack of claim 7, wherein:
the information handling system includes a power clip; and,
the information handling system position indication device is mounted to the power clip.

12. The information handling system server rack of claim 11, wherein:
the information handling system position indication device is mounted to an outside wall of the power clip.

13. An information handling system comprising:
a processor; and,
a power system for providing power to the processor, the power system comprising
an information handling system position indication device, the information handling system position indication device being configured to interact with a power distribution component position indication device of a power distribution system when the information handling system is mounted within an information handling system server rack to identify a location of the information handling system.

14. The information handling system of claim 13, wherein:
the power distribution system includes a busbar; and,
the power distribution component position indication device is mounted within the busbar.

15. The information handling system of claim 14, wherein:
the busbar includes a busbar housing, the busbar housing including a rear wall, a first side wall and a second side wall; and,
the power distribution component position indication device is mounted on an interior wall of at least one of the first side wall and the second side wall.

16. The information handling system of claim 13, wherein:
the power distribution component position indication device includes a plurality of position indicia, the plurality of position indicia being positioned at predefined locations along the power distribution system; and,
the information handling system position indication device interacts at least one of the plurality of position indica to identify a location of the information handling system.

17. The information handling system of claim 13, further comprising:
a power clip; and wherein,
the information handling system position indication device is mounted to the power clip.

18. The information handling system of claim 17, wherein:
the information handling system position indication device is mounted to an outside wall of the power clip.
